(19) United States
(12) Patent Application Publication
(10) Pub. No.: US 2003/0089775 A1
(43) Pub. Date: May 15, 2003

(54) Display-equipped optical reader having decode failure image display feedback mode

(75) Inventors: Daniel Yeakley, Monroe, NC (US); James T. Sauerwein JR., Charlotte, NC (US); Timothy P. Meier, Camillus, NY (US)

Correspondence Address: WALL MARJAMA & BILINSKI, 101 South Salina Street, Suite 400, Syracuse, NY, 13202, US

(73) Assignee: Welch Allyn Data Collection, Inc.

(21) Appl. No.: 09/862,024

(22) Filed: May 21, 2001

(51) Int. Cl. G06K 7/10; G06K 7/14

(52) U.S. Cl. 235/454

(57) ABSTRACT

The invention is an optical reader configured to operate in a decode fail image display feedback mode. When operating in a decode fail image display feedback mode, a reader according to the invention waits for a trigger to be actuated, and when a trigger is actuated captures a frame of image data and attempts to decode decodable indicia represented within the frame of image data. The reader displays an image corresponding to a recently captured frame of image data on the reader display to aid in the user in positioning the reader relative to a display, but only in the case that decoding is unsuccessful. If decoding succeeds no image is displayed on the reader display. By withholding display of an image corresponding to a captured frame unless and until there is an unsuccessful decoding attempt, a reader according to the invention provides a user with an image display feedback which aids positioning of a reader relative to a decodable indicia without deleteriously affecting initial positioning of the reader, which positioning is normally substantially accurate in the absence of display feedback.

### FIELD OF THE INVENTION

The invention relates to optical readers in general and specifically to optical readers of the type equipped with a display.

### BACKGROUND OF THE PRIOR ART

Attempts have been made in the prior art for using a display of a display-equipped optical to provide feedback to a user as to whether a reader is properly positioned relative to a decodable indicia, such as a decodable symbol or text string, during use of the reader for decoding.

U.S. Pat. Nos. 5,414,251 and 5,428,212 describe methods wherein, upon activation of a certain mode of operation, a representation of the frame of the last captured-frame of image data is displayed on an optical reader display and is constantly refreshed.

U.S. Pat. No. 5,414,251 describes a method wherein upon activation of a mode in which a display is used for aiming, a reader automatically and continuously captures low resolution frames of image data and displays the images on a reader display. The user observes the display, and depending on what is shown on the display, attempts to move the reader so that decodable indicia is located in the center of the field of view of the reader. Simultaneously while low resolution images are being displayed, the reader preliminarily analyzes image data of the displayed data to determine if the displayed data may comprise decodable indicia. If the reader determines that the low resolution image data may comprise decodable indicia, the reader switches to a high resolution image capture and decoding mode. In a high resolution image capture and decoding mode, the reader captures image data in high resolution and attempts to decode decodable indicia represented therein.

U.S. Pat. No. 5,428,212 described a method wherein upon activation of a mode in which a display is used for aiming, a reader automatically captures images and displays the images on a display. When a user determines that the display indicates that a decodable indicia is in the field of view of the reader, the user actuated a reader trigger to commence decoding operations. When decoding is commenced, a reader attempts to decode decodable indicia represented in the frame corresponding the presently displayed image frame.

Problems have been noted with the above methods for use in properly positioning an optical reader relative to a decodable indicia. It has been observed that automatically displaying images on a display screen prior to there being a user-actuated attempt to decode decodable indicia may actually deleterious affect the image capture and decoding process. The display of images on a display prior to there being an attempt to decode decodable indicia tends to divert the attention of a reader user from the indicia on a target to the indicia on the display. The accuracy of the user's first attempt to position a reader in proper position relative to a target decodable indicia is thereby deleteriously affected.

There is a need for a display equipped optical reader having a display feature which aids in positioning of the reader relative to a decodable indicia without deleteriously affecting the accuracy of the user's initial attempt to position the reader in an operative position relative to a decodable indicia.

### SUMMARY OF THE INVENTION

According to its major aspects and broadly stated, the invention is a display-equipped optical reader configured to be operated in a “Decode Failure Image Display Feedback Mode.”

In a decode failure image display feedback mode according to the invention, a reader captures a frame of image data when a trigger is actuated, attempts to decode decodable indicia represented in the frame, and displays on a reader display a representation of the captured image, but only in the case that decoding is unsuccessful. In the case decoding is successful the reader provides a user feedback that indicates that decoding has been successful, but does not display an image representation on display corresponding to a last or recently captured image. By withholding display of an image representation corresponding to a captured frame until and unless decoding fails, the invention aids a user in positioning an optical reader in a proper position relative to a decodable indicia without deleteriously affecting the accuracy of a user's initial attempt to position a reader in an operative reading position relative to an indicia bearing target substrate, which has been observed to be substantially accurate when made in the absence of image display feedback.

In one embodiment of the invention, the decode failure image display feedback mode of the invention is incorporated in an optical reader equipped with target illumination optics. A reader equipped with target illumination optics can be advantageously configured so that the decode failure image display feedback mode of operation is activated automatically when a high ambient illumination condiment is sensed. High ambient illumination conditions obscure the visibility of an aiming pattern generated by target illumination optics. Accordingly, configuring a target optic-equipped optical reader so that a decode failure image display feedback mode according to the invention is activated when a high ambient illumination condition is sensed assures that at least one reader position-aiding feature of the reader is operational under all expected operating conditions, including high ambient light operating conditions.

These and other details and advantages will become apparent from the detailed description of the preferred embodiment hereinbelow.

### BRIEF DESCRIPTION OF THE DRAWINGS

The preferred embodiment of the invention will now be described, by way of example only, with reference to the accompanying figures wherein like members bear like reference numerals and wherein:

FIGS. 1a through 1d show an optical reader according to the invention in various states of operation during the course of operating in a decode fail image display feedback mode according to the invention;

FIG. 1e shows a flow diagram illustrating operation of a reader according to the operation during the course of operating in a decode fail image display feedback mode according to the invention.

FIGS. 2a-2d show alternative embodiments of optical reading imaging devices in which the invention may be incorporated;

FIGS. 3a-3e show alternative electronic hardware for optical readers and reader communication systems for the invention;

FIG. 4a shows an architecture for a program memory of an optical reader according to the invention.

FIGS. 5-8 are flow charts illustrating various decoding functions of a reader according to the invention;

### DETAILED DESCRIPTION OF THE INVENTION

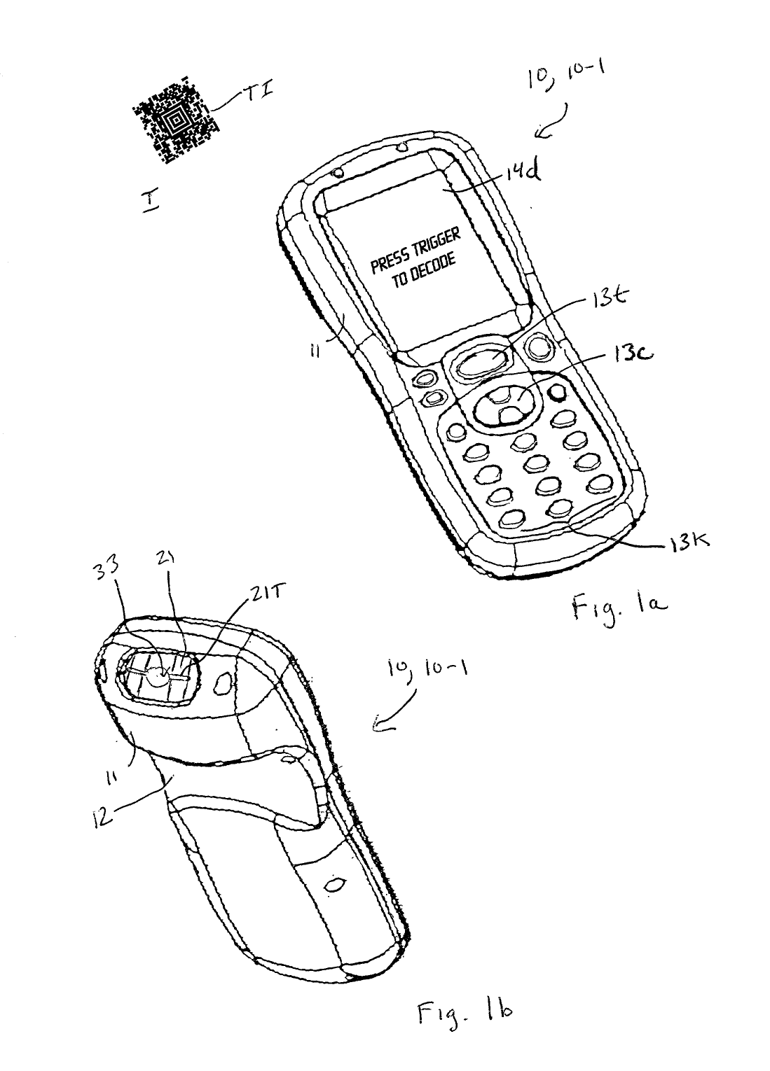

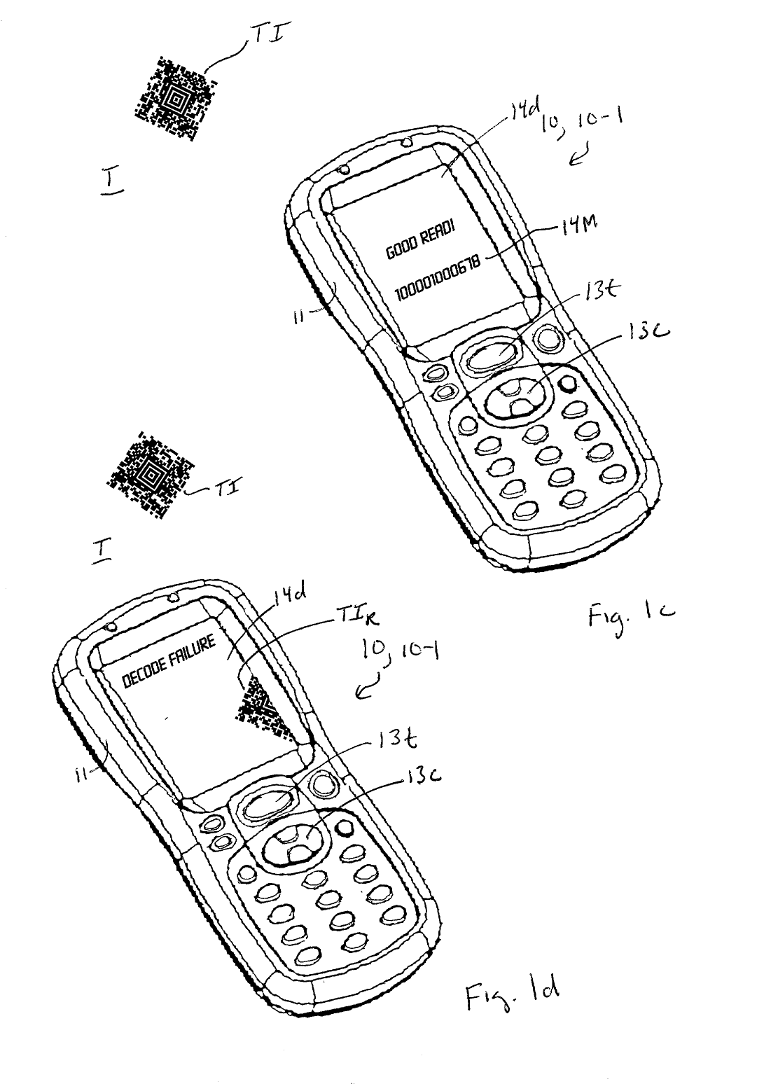

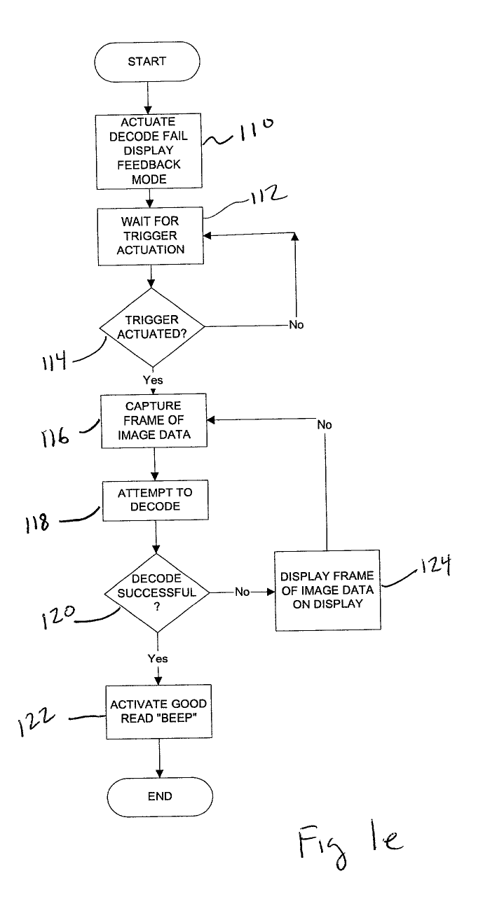

The invention is first described briefly with reference to FIGS. 1a, 1b, and id showing an optical reader 10 operating in accordance with a “Decode Failure Image Display Feedback” mode.

When the decode failure image feedback mode is activated, reader 10 waits for trigger 13t to be actuated. A reader in “wait for trigger pull” state is shown in FIG. 1a. In this state of operation in the decode failure image display feedback mode, reader 10 may display no indicia on display 14d, or else may display indicia indicating to a user that the reader is operating in a decoding mode of operation generally or specifically a decode failure image display feedback mode according to the invention. For example, reader 10 may display on reader display 14d a text display such as “Actuate Trigger to Commence Decoding” or “Press Trigger to Decode” as is indicated by the reader shown in FIG. 1a. Reader 10 may also display on display 14d, for example, the words “Decode Fail Feedback Mode” coupled with the words “Actuate Trigger to Commence Decoding” to indicate to a user both the present mode of operation of reader 10, and the action required of the user.

When a trigger 13t of reader 10 is actuated during operation in accordance of the decode failure image display feedback mode, reader 10 captures a frame of image data and attempts to decode decodable indicia represented therein, such as a bar code symbol or an OCR decodable text string. If the reader successfully decodes a decodable indicia represented in the captured frame, reader 10 may provide on display 14d an indicator indicating that decoding has been successful. For example, reader 10 may display on display a message such as “Decode Successful” or “Good Read” coupled with a character string 14m corresponding to the decoded out data as is indicated in the reader state shown by FIG. 1c.

If however, decoding is unsuccessful, reader 10 displays on display 14d image data corresponding to a frame of image data recently subjected to decoding (conveniently the frame of image data most recently subjected to decoding). The user can then observe the display 14d to correct the position of the reader relative to the decodable indicia. For example in a typical operation, the display 14d may indicate to a user that a decodable indicia is only partially contained in the field of view of a reader 10 as is indicated by the example of FIG. 1d, and the user may move the reader in an appropriate manner until the display 14d shows a representation of an entire decodable indicia and therefore indicates that the indicia is wholly contained in the field of view of reader 10. The user therefore is provided with displayed image feedback which aids in the positioning of reader 10 relative to an indicia but only in the case there is an attempt to decode image data and the attempt is unsuccessful.

The decode failure image display feedback mode according to the invention differs in important respects from prior art attempts to employ reader displays for use in positioning a reader relative to a decodable indicia. In the readers discussed in the background herein images corresponding to captured frames of image data are displayed prior to there being any attempt to decode decodable indicia represented within one of the captured and correspondingly displayed frames. However, such operation of a display-equipped reader can actually deleteriously affect the accuracy with which a user initially positions a reader relative to a decodable indicia TI bearing target substrate prior to there being a decode attempt.

When an image corresponding to frame of captured image data is displayed on a reader display 14d, a user's attention tends to be drawn to the image displayed on display 14d and away from indicia TI present on a target substrate T. This tendency of a displayed image to distract the attention of a user is especially deleterious to the operation of reader 10 in the case that the displayed image of display 14d appears to comprise a representation of decodable indicia which the user wishes to decode but in fact does not. In the case display 14d displays an image that comprises what appears to be a representation of decodable indicia but in fact is a representation of, for example, extraneous undecodable markings, then the user is likely to waste several seconds moving the reader in response to the displayed image. The user may waste more time if the user erroneously activates decoding operations in response to observing a displayed image on display 14d which appears to represent decodable indicia but in fact does not.

In developing the invention, the inventors observed that a user can make a good, reasonably accurate attempt to move a reader in an operative (decode enabling) position relative to an indicia TI, without any feedback, including without any image display feedback. If the user's feedback-free initial attempt to position a reader relative to an indicia prior to decoding attempt is not accurate enough so that the first captured frame after decoding commencement wholly contains a decodable indicia, then it is usually accurate enough such that a first captured frame subsequent to a trigger actuation at least partially comprises a representation of the decodable indicia desired to be decoded. When a first frame of image data, in accordance with the invention, is written to display 14d, then, there is a strong likelihood that the first frame comprises at least a partial representation of the decodable indicia a user wishes to decode. The invention therefore operates to assure that the first image displayed by display 14d comprises displayed image feedback that encourages a user to center the field of view of reader 10 on decodable indicia and not displayed image feedback which encourages to center the field of view of reader 10 on extraneous undecodable markings, for example.

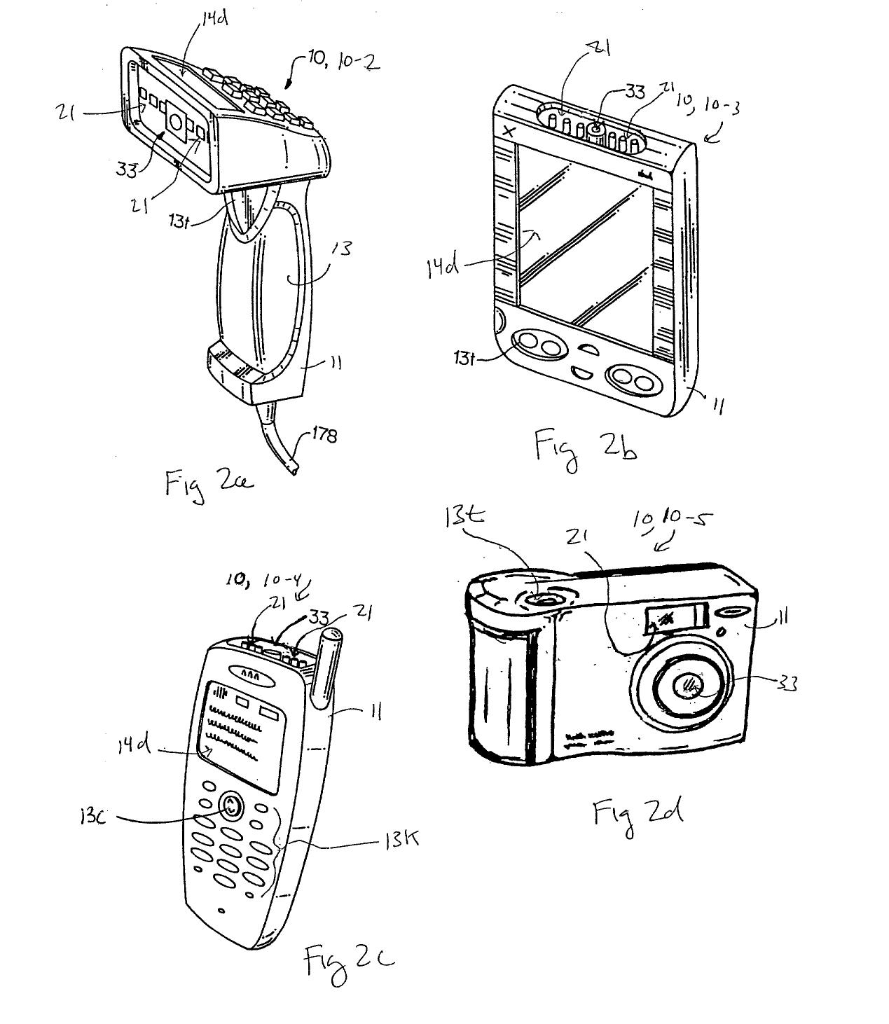

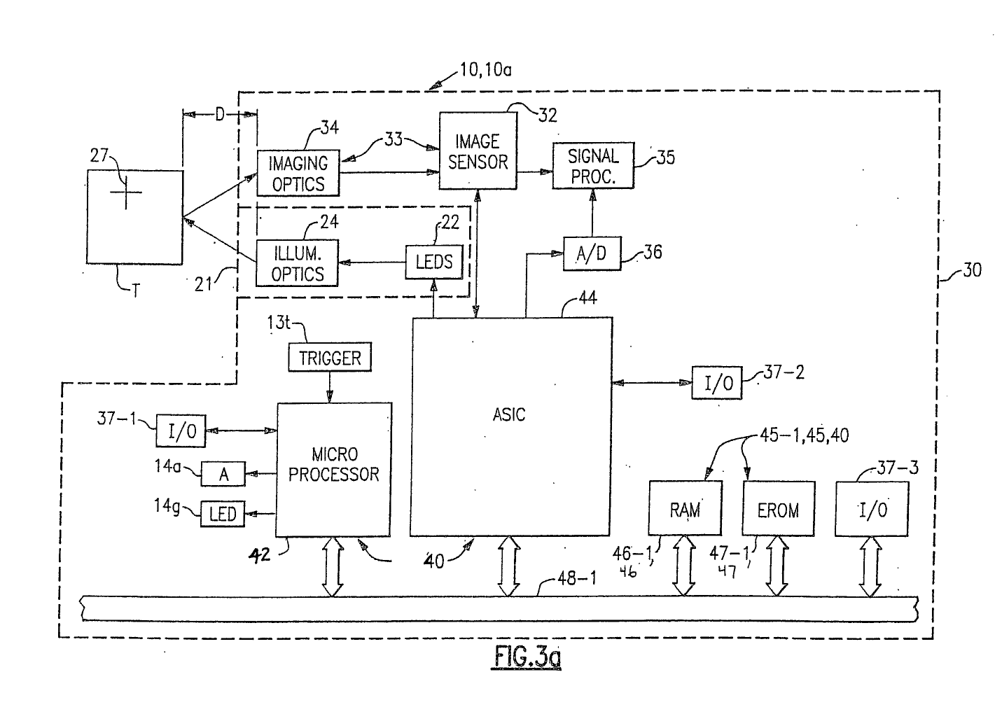

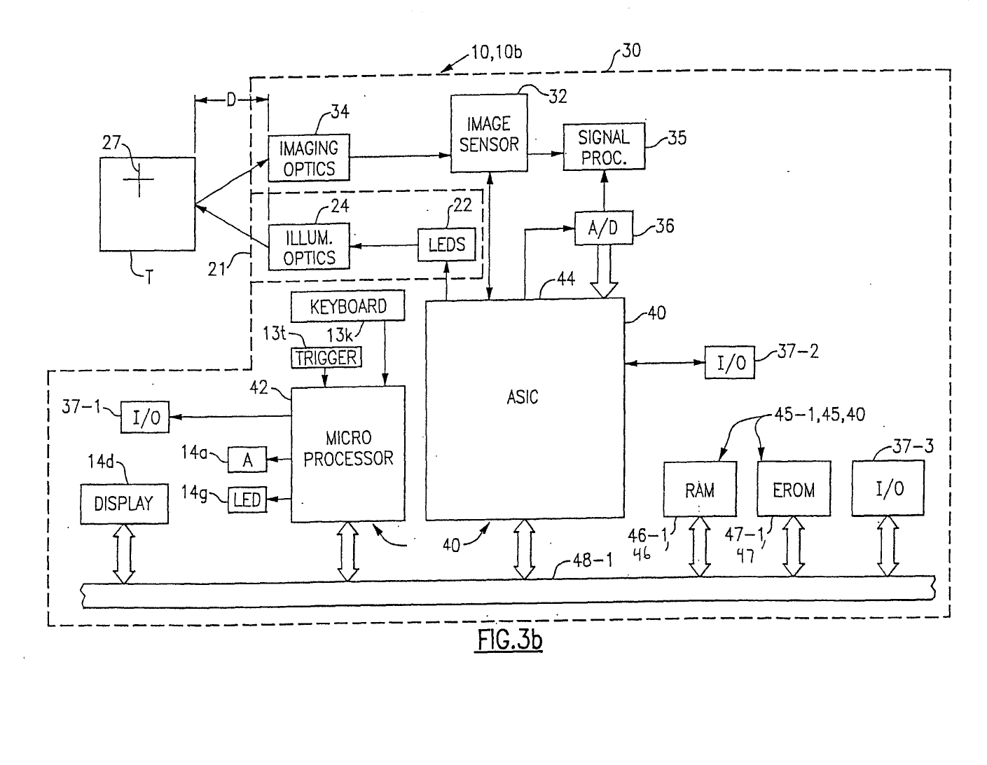

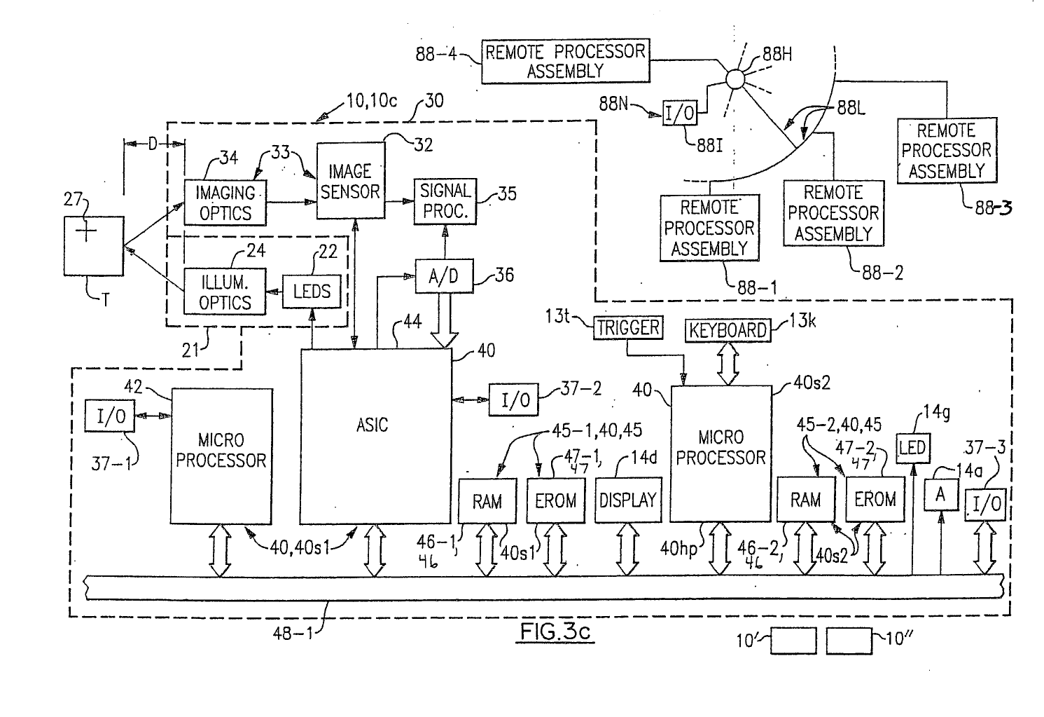

Shown in the embodiment of FIGS. 1a through 1b as being provided by a keyboard equipped data collection device having a finger saddle 12, reader 10 may take on a variety of forms. For example, the invention can be incorporated in a “gun” styled optical reader 10, 10-2 having a handle 13, as indicated in the embodiment of FIG. 2a, or a palm-held personal computer, or personal data assistant (PDA) 10, 10-3 indicated in the example of FIG. 2b. The invention can also be incorporated in a wireless portable telephone 10, 10-4 as indicated by the example of FIG. 2c or in a digital camera 10, 10-5 as indicated by FIG. 2d. All of the above readers 10-1, 10-2, 10-3, 10-4, and 10-5 have incorporated therein an imaging apparatus 33 which includes at least imaging optics, and an image sensing device. The above readers also include an illumination assembly 21 for illuminating a target area, T. In the embodiments of FIGS. 1a-2c illumination assembly 21 typically comprises LEDs. Illumination assembly 21 of the digital camera 10-4 of FIG. 2d typically comprises a flash illuminator. All of the above readers 10-1, 10-2, 10-3, 10-4 and 10-5 also comprise a hand-held portable housing 11.

Shown as being provided by a hand held portable device, it will be understood that the invention can be incorporated in a presentation reader wherein display 14d serves to guide a user in moving a target indicia TI in a proper position relative to reader 10 rather than serving to guide a user in positioning reader 10 in a proper position relative to TI.

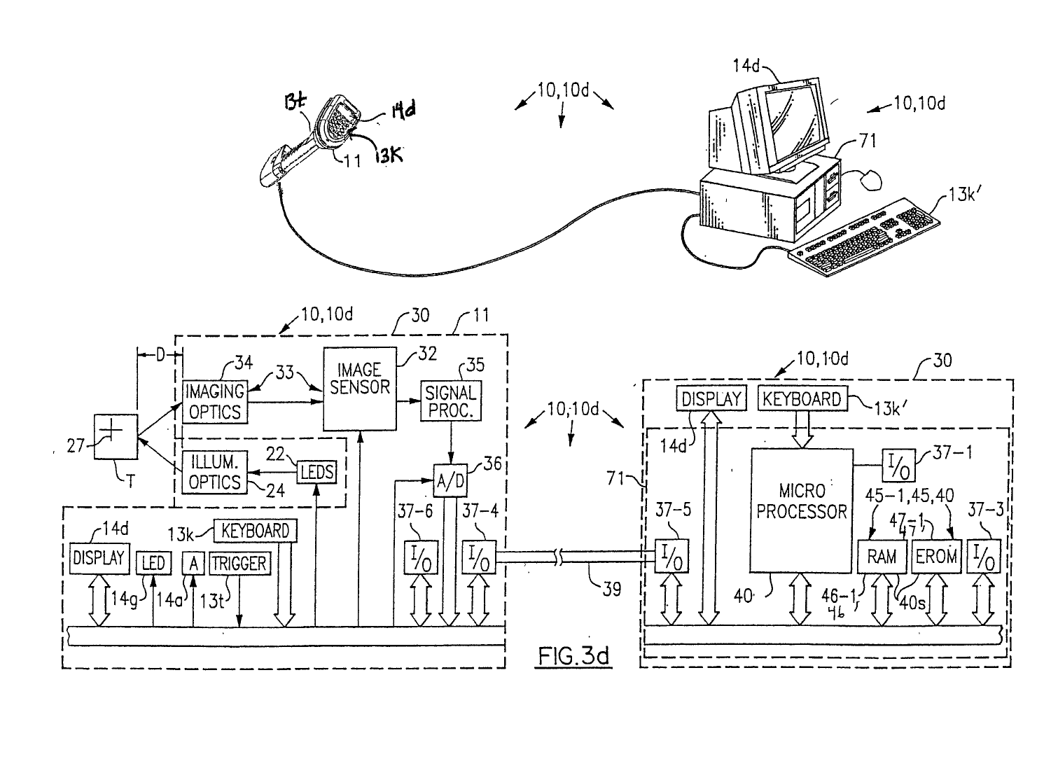

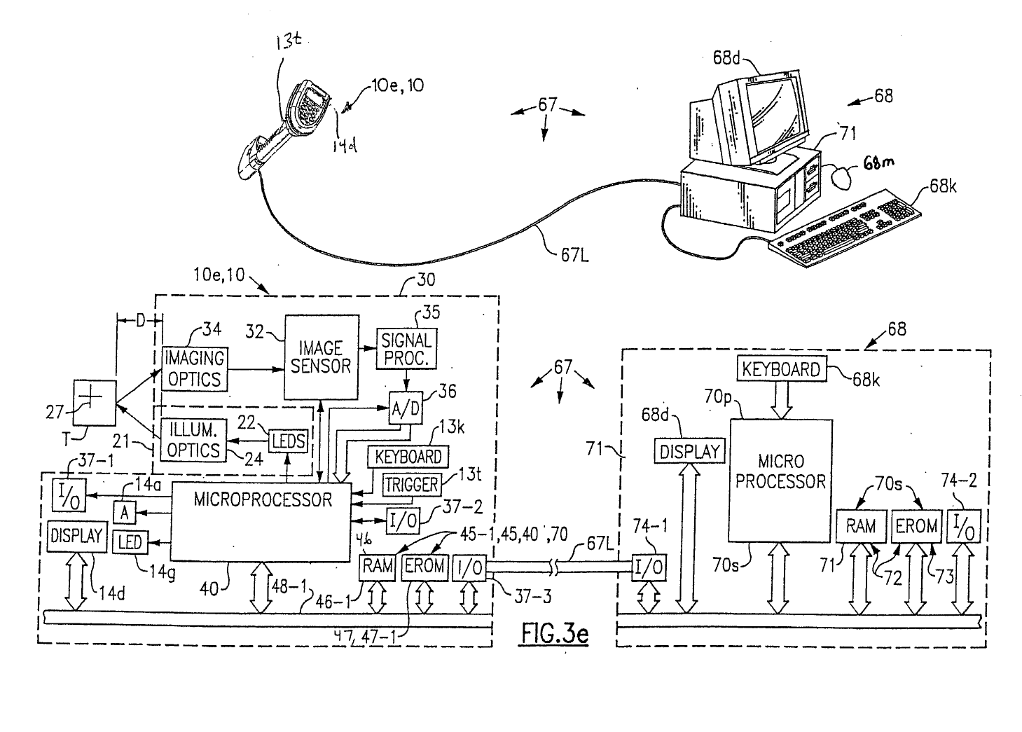

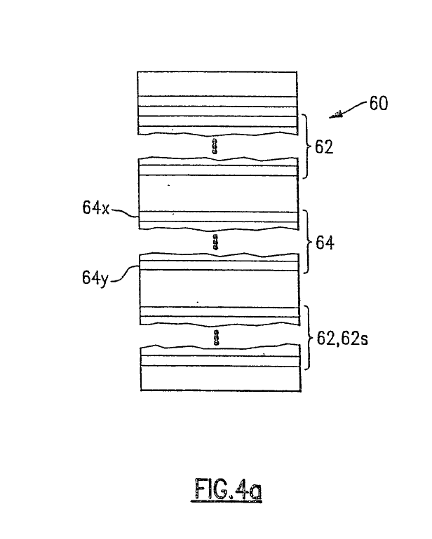

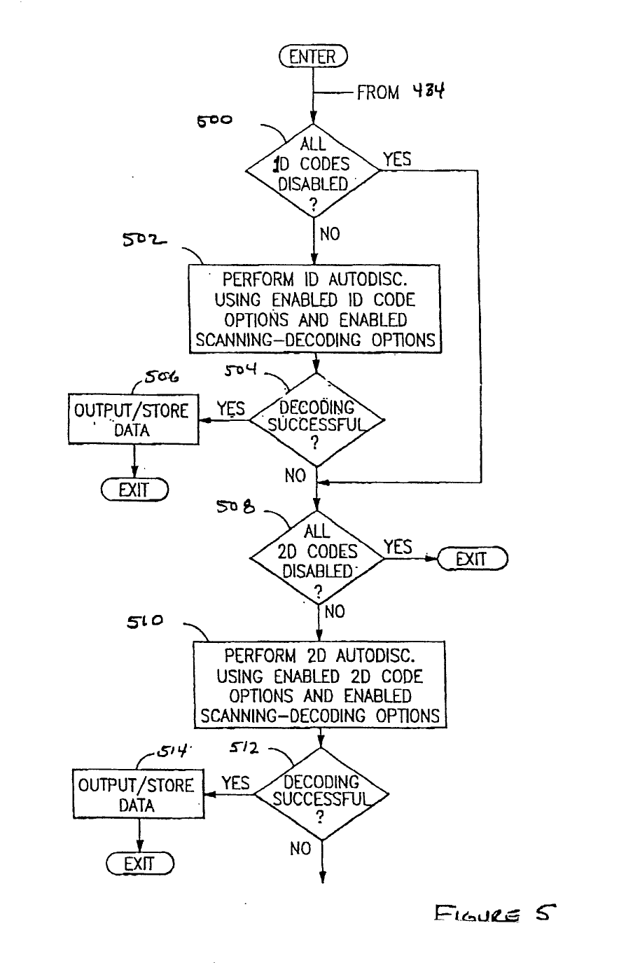

Block diagrams illustrating various types of electronic hardware configurations for optical readers in which the invention may be incorporated and communication systems comprising at least one optical reader described with reference to FIGS. 3a-3e. Referring to FIG. 3a, optical reader 10a includes a reader processor assembly 30.

Reader processor assembly 30, includes an illumination assembly 21 for illuminating a target area T, such as a substrate bearing a 1D or 2D bar code symbol or a text string, and an imaging assembly 33 for receiving an image of object T and generating an electrical output signal indicative of the data optically encoded therein. Illumination assembly 21 may, for example, include an illumination source assembly 22, together with an illuminating optics assembly 24, such as one or more lenses, diffusers, wedges, reflectors or a combination of such elements, for directing light from light source 22 in the direction of a target object T. Illumination assembly 21 may comprise, for example, laser or light emitting diodes (LEDs) such as white LEDs or red LEDs. Illumination assembly 21 may include target illumination optics 2IT for projecting an aiming pattern 27 on target T. Illumination assembly 21 may be eliminated if ambient light levels are certain to be high enough to allow high quality images of object T to be taken. Illumination assembly 21 may also be located remote from reader housing 11, at a location so as to eliminate or reduce specular reflections. Imaging assembly 33 may include an image sensor 32, such as a color or monochrome 1D or 2D CCD, CMOS, NMOS, PMOS, CID or CMD solid state image sensor, together with an imaging optics assembly 34 for receiving and focusing an image of object T onto image sensor 32. The array-based imaging assembly shown in FIG. 3a may be replaced by a laser array based imaging assembly comprising one or more laser sources, a scanning mechanism, emit and receive optics, at least one photodetector and accompanying signal processing circuitry.

Reader processor assembly 30 of the embodiment of FIG. 3a also includes programmable control circuit 40 which preferably comprises an integrated circuit microprocessor 42 and an application specific integrated circuit (ASIC 44). The function of ASIC 44 could also be provided by field programmable gate array (FPGA). Processor 42 and ASIC 44 are both programmable control devices which are able to receive, output and process data in accordance with a stored program stored in memory unit 45 which may comprise such memory elements as a read/write random access memory or RAM 46, 46-1 and an erasable read only memory or EROM 47, 47-1. Memory 45 may also include one or more long term non-volatile memory devices (not shown). For example, memory 45 may include e.g. a hard drive, a transportable flash disk, or memory stick to which data can be written to or read from. Processor 42 and ASIC 44 are also both connected to a common bus 48-1 through which program data and working data, including address data, may be received and transmitted in either direction to any circuitry that is also connected thereto. Processor 42 and ASIC 44 differ from one another, however, in how they are made and how they are used.

More particularly, processor 42 is preferably a general purpose, off-the-shelf VLSI integrated circuit microprocessor which has overall control of the circuitry of FIG. 2a, but which devotes most of its time to decoding decodable image data such as symbology or text character data stored in RAM 46, 46-1 in accordance with program data stored in EROM 47, 47-1. ASIC 44, on the other hand, is preferably a special purpose VLSI integrated circuit, such as a programmable logic or gate array, which is programmed to devote its time to functions other than decoding image data, and thereby relieve processor 42 from the burden of performing these functions.

The actual division of labor between processor 42 and ASIC 44 will naturally depend on the type of off-the-shelf microprocessors that are available, the type of image sensor which is used, the rate at which image data is output by imaging assembly 33, etc. There is nothing in principle, however, that requires that any particular division of labor be made between processors 42 and 44, or even that such a division be made at all.

With processor architectures of the type shown in FIG. 3a, a typical division of labor between processor 42 and ASIC 44 will be as follows. Processor 42 is preferably devoted primarily to such tasks as decoding image data in response to trigger 13t being activated, once such data has been stored in RAM 46, 46-1 and, recognizing characters represented in stored image data according to an optical character recognition (OCR) scheme in response to an actuation of trigger 13t.

ASIC 44 is preferably devoted primarily to controlling the image acquisition process, the A/D conversion process and the storage of image data, including the ability to access memories 46-1 and 47-1 via a DMA channel. ASIC 44 may also perform many timing and communication operations. ASIC 44 may, for example, control the illumination of LEDs 22, the timing of image sensor 32 and an analog-to-digital (A/D) converter 36-1, the transmission and reception of data to and from a processor system external to assembly 30, through an RS-232, a network such as an ethernet, a serial bus such as USB, a wireless communication link (or other) compatible I/O interface as is indicated by interface 37-2. ASIC 44 may also control the outputting of user perceptible data via an output device, such as aural output device 14a, a good read LED 14g and/or a display monitor which may be provided by a liquid crystal display such as display 14d. Control of output, display and I/O functions may also be shared between processors 42 and 44, as suggested by bus driver I/O interface 37-3 or duplicated, as suggested by microprocessor serial I/O interface 37-1 and interface 37-2. As explained earlier, the specifics of this division of labor is of no significance to the present invention. The reader described with reference to FIG. 3a can be adapted for use in connection with the invention by providing a display, e.g. display 68d that is external to hand-held housing 11, but is in communication with control circuit 40.

FIG. 3b shows a block diagram exemplary of an optical reader which is adapted to easily receive user-input control instructions resulting in a change in an operating program of a reader. In addition to having the elements of single state reader circuit of FIG. 3a, reader lob includes a keyboard 13k for inputting data including instructional data and a display 14d for displaying text and/or graphical information to an operator. Keyboard 13k may be connected to bus 48-1, ASIC 44 or to processor 42 as indicated in FIG. 2b. Display 14d may be connected to ASIC 44, to processor 42 or to system bus 48-1 as is indicated in the particular embodiment of FIG. 3b.

An operator operating optical reader lob can reprogram reader 10b in a variety of different ways. In one method for reprogramming reader 10-b, an operator actuates a control button of keyboard 13k which has been pre-configured to result in the reprogramming of reader lob. In another method for reprogramming reader lob an operator actuates control of a processor system not integral with reader lob to transmit an instruction to reprogram reader lob. According to another method for reprogramming reader lob, an operator moves reader lob so that a “menu symbol” is in the field of view of image sensor 32 and then activates trigger 13t of reader lob to capture an image representation of the menu symbol. A menu symbol is a specially designed bar code symbol which, when read by an appropriately configured optical reader results in a reader being programmed. The reprogramming of an optical reader with use of a menu symbol is described in detail in commonly assigned U.S. Pat. No. 5,965,863 incorporated herein by reference. Because the second and third of the above methodologies do not require actuation of a reader control button of keyboard 13k but nevertheless result in a reader being reprogrammed, it is seen that reader 10 may be keyboardless but nevertheless reprogrammable. It will be seen that the second or third of the above methodologies can be adapted for selecting operating modes described herein.

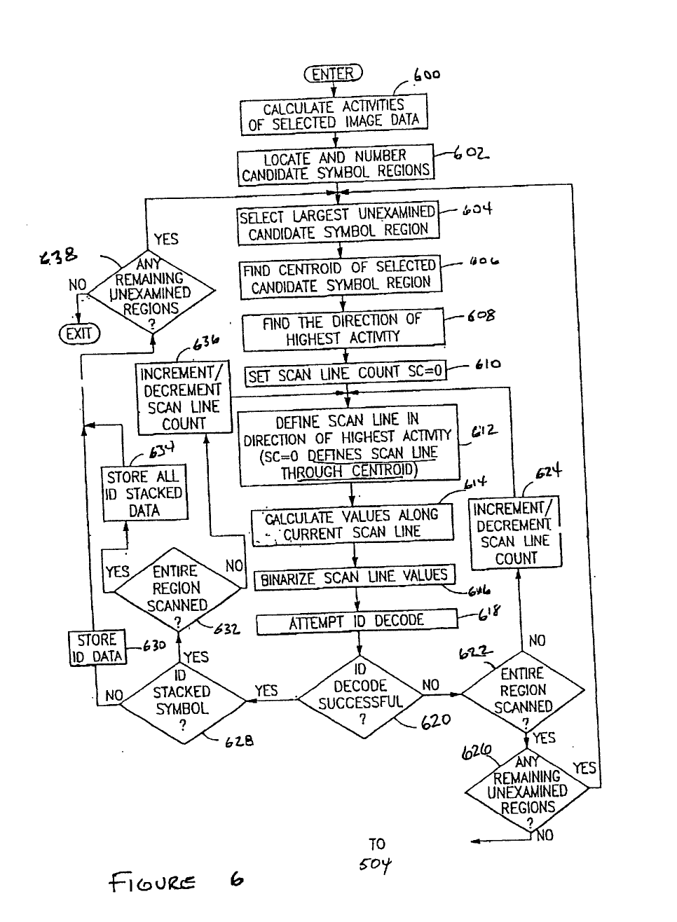

A typical software architecture for an application operating program typically executed by an optical reader as shown in FIG. 3b is shown in FIG. 4a depicting a memory map of a program stored in program memory 47-1. Application operating program 60 adapts a reader for a particular application. Three major applications or functions for an optical reader imaging device having image capture capability are: (1) comprehensive decoding; (2) data transfer; and (3) signature capture. In a comprehensive decoding application, reader 10 may preliminarily analyze and then decode a message corresponding to a bar code symbol or OCR decodable text character. In a data transfer application, reader 10 uploads character text files or image files to a processor system located externally relative to reader housing 11. In a signature capture application, reader 10 may capture an image corresponding to a scene having a signature, parse out from the image data that image data corresponding to a signature, and transmit the captured signature data to another processing system. It is seen that the third of such applications can be carried out by an optical reader imaging device that is not an optical reader decoder equipped with decoding capability. Numerous other application operating programs are, of course possible, including a specialized 1D decoding application, a specialized 2D bar code decoding algorithm, a specialized OCR decoding application which operates to decode OCR decodable text characters, but not bar code symbols. A user of a reader configured in accordance with the invention accesses a mode selector menu driver as exemplified by the embodiment of shown in FIG. 1a when a decoding function of the reader is actuated.

Referring now to specific aspects of the software architecture of an operating program 60, program 60 includes an instruction section 62, and a parameter section 64. Further, instruction section 62 may include selectable routine section 62s. Instructions of instruction section 62 control the overall flow of operations of reader 10. Some instructions of instruction section 62 reference a parameter from a parameter table of parameter section 64. An instruction of instruction section 62 may state in pseudocode, for example, “set illumination to level determined by [value in parameter row x].” When executing such an instruction of instruction section 62, control circuit 40 may read the value of parameter row 64x. An instruction of instruction section 62 may also cause to be executed a selectable routine, that is selected depending on the status of a parameter value of parameter section 64. For example, if the application program is a bar code decoding algorithm then an instruction of instruction section 62 may state in pseudocode, for example, “launch Maxicode decoding if Maxicode parameter of parameter row 64y is set to “on”. When executing such an instruction, control circuit 40 polls the contents of row 64y of parameter section 64 to determine whether to execute the routine called for by the instruction. If the parameter value indicates that the selectable routine is activated, control circuit 40, executes the appropriate instructions of routine instruction section 62s to execute the instruction routine.

It is seen, therefore, that the above described software architecture facilitates simplified reprogramming of reader 10. Reader 10 can be reprogrammed simply by changing a parameter of parameter section 64 of program 60, without changing the subroutine instruction section 62s or any other code of the instruction section 62 simply by changing a parameter of parameter section 64. The parameter of a parameter value of section 62 can be changed by appropriate user control entered via keyboard 13k, by reading a menu symbol configured to result in a change in parameter section 64, or by downloading a new parameter value or table via a processor system other than system 40 as shown in FIGS. 3a and 3b. The reprogramming of reader lob can of course also be accomplished by downloading an entire operating program including sections 62 and 64 from a processor system other than a system as shown in FIGS. 3a and 3b.

Another architecture typical of an optical reader which may be configured in accordance with the invention is shown in FIG. 3c. Reader 10c comprises a control circuit 40 having a processor system 40s1, and an integrated host processor system 40s2 which includes host processor 40hp and an associated memory 45-2. “Host processor system” herein shall refer to any processor system which stores a reader application operating program for transmission into a processor system controlling operation of a reader imaging system 33 or which exercises supervisory control over a processor system controlling operation of a reader imaging system 33, or which stores in its associated memory more than one application operating program that is immediately executable on reception of a command of a user. In a reader having two processors such as processor 42 and processor 40hp, processor 42 is typically dedicated to processing image data to decode decodable indicia, whereas processor 40hp is devoted to instructing processor 42 to execute decoding operations, receiving inputs from trigger 13t and keyboard 13k, coordinating display and other types of output by output devices 14d, 14g, and 14a and controlling transmissions of data between various processor systems.

In architectures shown in FIG. 3c having dedicated decoding processor system 40s1 and a powerful, supervisory host processor system 40s2, host processor system 40s2 commonly has stored thereon an operating system, such as DOS WINDOWS or WINDOWS, or an operating system specially tailored for portable devices such as, WINDOWS CE available from Microsoft, Inc. In the case that host processor system 40s2 includes an operating system such as DOS or WINDOWS CE, the instruction section and parameter section of the operating program controlling the operation of host processor system 40s2 normally are programmed in a high level programming language and assembled by an assembler before being stored in memory 47-2 and therefore may not reside in consecutive address locations as suggested by program 60 shown in FIG. 4a. Nevertheless, host processor system 40s2 having an operating system integrated thereon can readily assemble an operating program into such a form for loading into an external processor system that does not have an operating system stored thereon.

Referring to further aspects of readers 10a, 10b, and 10c at least one I/O interface e.g. interface 37-1, 37-2, and 37-3 facilitates local “wired” digital communication such as RS-232, ethernet, serial bus including Universal Serial Bus (USB), or local wireless communication technology including “Blue Tooth” communication technology. At least one I/O interface, e.g. interface 37-3, meanwhile, facilitates digital communication with remote processor assembly 88-1 in one of available remote communication technologies including dial-up, ISDN, DSL, cellular or other RF, and cable. Remote processor assembly 88-1 may be part of a network 88N of processor systems as suggested by assemblies 88-2, 88-3, and 88-4 links 88L and hub 88H e.g. a personal computer or main frame computer connected to a network, or a computer that is in communication with reader 10c only and is not part of a network. The network 88N to which assembly 88-1 belongs may be part of the internet. Further, assembly 88-1 may be a server of the network and may incorporate web pages for viewing by the remaining processor assemblies of the network. In addition to being in communication with reader 10c, assembly 88-1 may be in communication with a plurality of additional readers 10′ and 10″. Reader 10c may be part of a local area network (LAN). Reader 10 may communicate with system 88-1 via an I/O interface associated with system 88-1 or via an I/O interface 88I of network 88N such as a bridge or router. Further, a processor system external to processor system 40 such as processor system 70s may be included in the communication link between reader 10 and assembly 88-1. While the components of readers 10a, 10b, and 10c are represented in FIGS. 3a-3c as discreet elements it is understood that integration technologies have made it possible to form numerous circuit components on a single integrated circuit chip. For example, with present fabrication technologies, it is common to form components such as components 42, 40, 46-1, 47-1, 37-2, and 37-1 on a single piece of silicone.

Furthermore, the number of processors of reader 10 is normally of no fundamental significance to the present invention. In fact if processor 42 is made fast enough and powerful enough special purpose ASIC processor 44 can be eliminated. Likewise, referring to reader 10c, a single fast and powerful processor can be provided to carry out all of the functions contemplated by processors 40hp, 42, and 44 as is indicated by the architecture of reader 10e of FIG. 3e. Still further, it is understood that if reader 10 includes multiple processors the processors may communicate via parallel data transfers rather than via the serial communication protocol indicated by serial buses 48-1 and 48-2. In addition, there is no requirement of a one-to-one correspondence between processors and memory. Processors 42 and 40hp shown in FIG. 3c could share the same memory, e.g. memory 45-1. A single memory e.g. memory 45-1 may service multiple processors e.g. processor 42 and processor 40 hp.

Referring to the embodiment of FIG. 3d, it is seen that it is not necessary that the entirety of electrical components of an optical reader 10 be incorporated in a portable device housing 11. The electrical components of reader 10d are spread out over more than one circuit board that are incorporated into separate device housings 11 and 71. It is understood that circuitry could be spread out into additional housings. Control circuit 40 in the embodiment of FIG. 3d is incorporated entirely in the housing 71 that is non-integral with portable device housing 11. Housing 71 is shown as being provided by a personal computer housing, but could also be provided by another type of housing such as a cash register housing, a transaction terminal housing or a housing of another portable device such as housing 11. At least one operating program for controlling imaging assembly 33 and for processing image signals generated from imaging assembly 33 is stored in EROM 47-1 located within PC housing 71. For facilitating processing of signals generated from imaging assembly 33 by a processor system that is not integrated into portable housing 11 a high speed data communication link should be established between imaging assembly 33 and processor system 40. In the embodiment of FIG. 3d, I/O interfaces 37-4 and 37-5 and communication link 39 may be configured to operate according to the USB data communication protocol. The configuration shown in FIG. 3d reduces the cost, weight, and size requirements of the portable components of reader 10d, which in reader 10-4 are the components housed within portable housing 11. Because the configuration of FIG. 3d results in fewer components being incorporated in the portable section 11 of reader 10d that are susceptible to damage, the configuration enhances the durability of the portable section of reader 10-4 delimited by housing 11.

The control circuit 40 as shown in the embodiment of FIG. 3d can be in communication with more than one “shell” processorless reader comprising a reader housing and a reader circuitry shown by the circuitry within dashed housing border 11 of FIG. 3d. In the case that a control circuit as shown in FIG. 3d services many “shell” readers or processor-equipped readers input/output port 37-5 should be equipped with multiplexing functionality to service the required data communications between several readers and/or shell readers and a single processor system.

The reader communication system of FIG. 3e has a physical layout identical to reader 10d, but is optimized for a different operation. System 67 is a communication system in which reader processor system 40 communicates with a nonintegrated local host processor system 70s provided by a personal computer 68 having a PC housing 71, a keyboard 68k, a mouse 68m, and a display 68d. Provided that link 67L is a high speed communication link, nonintegrated local host processor system 70s could be programmed to provide functioning identical to processor system 40s of reader 10d. However, because reader 10e comprises an integrated processor system 40 such programming is normally unnecessary, although as described in copending application Ser. No. 09/385,597, incorporated by reference herein it is useful to configure processor system 40 communication with a host processor system e.g. 70s so that certain components of reader 10 such as trigger 13t can be controlled remotely by host processor system 70s, which in one embodiment is nonintegrated. Accordingly, in reader-host communication systems as shown in FIG. 3e nonintegrated host processor assembly 68 typically is programmed to provide functions separate from those of the reader processor systems described in connection with FIGS. 3a-3d.

As described in U.S. Pat. No. 5,965,863, incorporated herein by reference, one function typically provided by nonintegrated local host processor system 70s is to create operating programs for downloading into reader 10. Processor system 70s typically has an operating system incorporated therein, such as WINDOWS, which enables an operator to develop operating programs using a graphical user interface, which may be operated with use of a pointer controller 13c. Nonintegrated local processor system 70s also can be configured to receive messages an/or image data from more than one reader, possibly in a keyboard wedge configuration as described in U.S. Pat. No. 6,161,760, incorporated herein by reference. It is also convenient to employ processor system 70 for data processing. For example a spreadsheet program can be incorporated in system 70s which is useful for analyzing data messages from reader 10e. An image processing application can be loaded into system 70s which is useful for editing, storing, or viewing electronic images received from reader 10e. It is also convenient to configure reader 10e to coordinate communication of data to and from a remote processor assembly such as assembly 88-1. Accordingly processor assembly 68 typically includes I/O interface 74-2 which facilitates remote communication with a remote processor assembly, e.g. assembly 88-1 as shown in FIG. 3c.

Referring again to specific features of the present invention, the invention is described in greater detail with reference to FIG. 1e showing a flow chart indicating steps to be executed by control circuit 40 in an exemplary embodiment of the invention.

At block 110 control circuit 40 receives an instruction causing control circuit 40 to operate in a decode fail image display feedback mode according to the invention. Reader 10 can be configured that so that the instruction causing reader 10 to operate in a decode fail image display feedback mode is generated by a user input command, input by user to reader 10 via, for example, keyboard 13k or keyboard 68k, or by the reading of menu symbols as described previously herein.

Reader 10 can also be configured so that the instruction causing control circuit 40 to operate in a decode fail display mode according to the invention is generated by control circuit 40 sensing a predetermined condition. The predetermined condition causing such a mode activation instruction to be generated may be, for example, that a certain type of bar code symbol is being read, or that the present user is a certain user. In a highly useful embodiment of the invention, the instruction causing reader 10 to operate in a decode fail image display feedback mode is generated when control circuit 40 senses a high ambient illumination condition. Under high ambient illumination conditions, the pattern of light generated by illumination assembly may be obscured, and if reader 10 comprises target illumination optics, the aiming pattern 27 generated by target illumination optics of assembly 21 may be obscured. Exemplary target illumination optics of an illumination assembly are described in greater detail in commonly assigned copending application Ser. No. 09/802,579 entitled “Imaging Module for Optical Reader Comprising Refractive Diffuser” filed Mar. 8, 2001, and incorporated by reference herein. Therefore, under certain high ambient illumination conditions, a user does not have substantial light pattern feedback (the user cannot clearly see either the overall target illumination pattern generated by illumination assembly 21 or the aiming pattern 27 generated by targeting optics of assembly 21) that indicate to a user that a certain decodable indicia that a user wishes to decode is in the field of view of reader.

Accordingly, configuring reader 10 so that operation in the decode fail image display feedback mode commences when there is a sensed high ambient illumination condition assures that at least one position aiding feature of reader 10 is functional under all ambient illumination conditions, including high ambient light conditions.

A high ambient illumination condition may be considered to be sensed in a variety of ways. For example, control circuit 40 may determine that a high ambient illumination condition exists if the output of a sensor circuit comprising a dedicated photodetector on or proximate reader 10 dedicated for sensing ambient light levels exceeds a predetermined level. Control circuit 40 may also determine that a high ambient illumination condition exists if an “illumination signal” derived from image signals generated by an ambient light sensor circuit comprising image sensor 32 exceeds a certain level. Such an illumination signal may be determined based on the value of a pixel or a group of pixels of one or more frames of image data captured by control circuit 40.

Of course, in addition to control circuit 40 commencing operation in a decode failure image display feedback mode, reader 10 can be configured so that the decode fail image display feedback is always operational whenever reader 10 is operated for the application of decoding decodable indicia.

At block 112 control circuit 40 waits for trigger 13t to be activated. When trigger 13t is actuated at block 114, control circuit 40 proceeds to block 116 to capture a frame of image data into memory 45 and at block 118 subjects the frame of captured image data to a decode attempt.

It is understood as explained in copending application Ser. No. 09/766,922 entitled “Optical Reader Having Reduced Parameter Determination Delay” filed Jan. 22, 2001, incorporated herein by reference, that prior to capturing a frame of image data which is subjected to decoding at block 116, control circuit 40 may actually capture several frames of image data which are subjected to analyses for purposes of establishing various parameter settings. Because such parameter setting frame capture steps are well known they are not referenced in the flow diagram, of FIG. 1e.

Various methods for decoding decodable indicia, including 1D symbols, 2D symbols, and text characters represented in captured image data are known. As indicated by the flow diagram of FIG. 1e, control circuit 40 attempts to decode decodable indicia at block 118. Specific features of exemplary algorithms for decoding decodable indicia represented in a captured frame of image data are described with reference to FIGS. 5, 6, 7, and 8.

As embodied herein and depicted in FIG. 5, a flow chart showing a method for attempting to decode decodable indicia is described. In step 500, control circuit 40 refers to parameter table 64 stored in EROM 48 as described with reference to FIG. 4a. Specifically, control circuit 40 determines if the parameter table is programmed to perform 1D decoding. If the parameter table has enabled 1D processing, 1D autodiscrimination is performed. The parameter table specifies the values of the parameters that define the operational mode of the reader. Examples of these parameters include the size and frame rate of image sensor 32, codes that are enabled during bar code decoding, I/O communications protocols, OCR options, and others. If 1D decoding is successful, the decoded data is stored and possibly displayed, in accordance with the parameter table settings. If 1D codes are disabled or if 1D decoding is unsuccessful, control circuit moves on to step 508. In this step, control circuit 40 determines if any 2D codes are enabled. If the parameter table has all of the 2D codes disabled, control circuit 40 exits the bar code decoding routine. If 2D codes are enabled, 2D autodiscrimination is performed in step 510. If decoding is successful, the decoded data is either stored or output, depending on the parameters stored in the parameter table. If decoding is unsuccessful, control circuit 40 exits the routine.

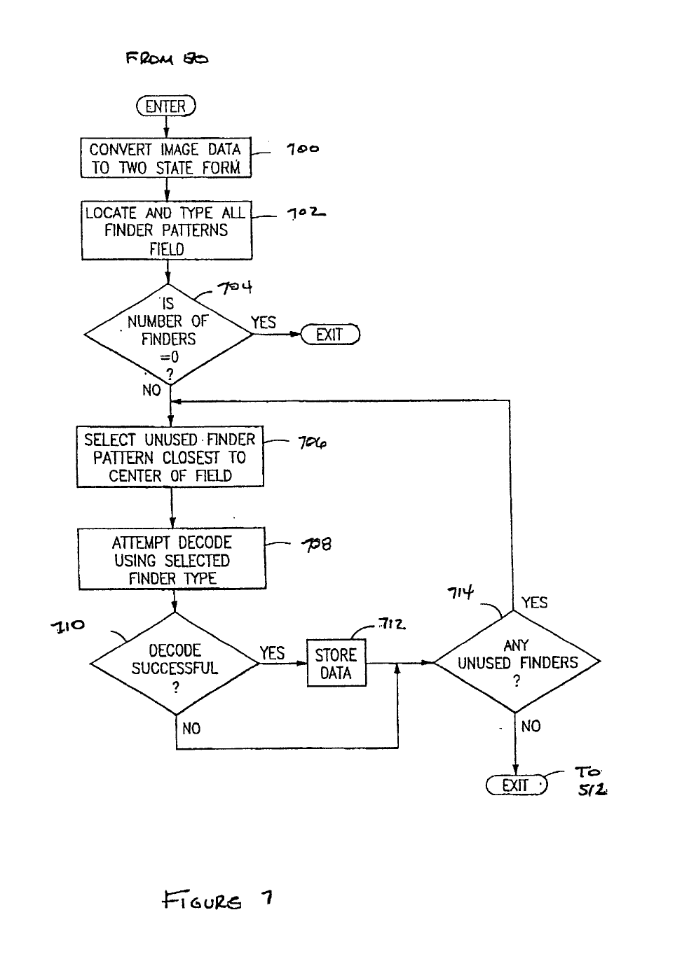

As embodied herein and depicted in FIG. 6, a flow chart showing a method for performing the 1D autodiscrimination of step 502 in FIG. 5 is disclosed. In step 600 control circuit 40 calculates the activities of selected image data elements. The activity is defined as a measure of the rate of change of the image data over a small two-dimensional portion of the region surrounding the selected data element. In one embodiment, the activity is calculated along any two arbitrarily selected directions which are orthogonal one to the other. Two mutually perpendicular directions are used because the orientation of the symbol is unknown. In step 602, control circuit 40 looks for “high activity” regions. These high activity regions are referred to as candidate symbol regions (CSRs). A high activity region indicates a transition from a black region to a white region, or vice-versa. If there is more than one CSR, it may indicate the presence of more than one bar code symbol. In step 604, control circuit 40 selects the largest CSR. In step 606, control circuit 40 calculates the centroid of the largest CSR. Subsequently, control circuit 40 finds the direction of the highest activity in the largest CSR. In a 1D bar code, this will be the direction perpendicular to the direction of the bars. In steps 610 and 612, control circuit 40 defines the initial scan line (SC=0), as being the scan line bisecting the centroid of the bar code. Control circuit 40 calculates the brightness values of sampling points along the initial scan line. These brightness values are converted to digital data in step 616. In decoding step 618, control circuit 40 applies one 1D decoding program after another. If decoding is unsuccessful, control circuit 40 checks if the entire CSR has been scanned. If not, it establishes a new scan line, and repeats the decoding process. If in step 622, the entire CSR has been scanned, and there are no CSRs remaining to be decoded, control circuit 40 exits the routine. If in step 620, 1D decoding is successful, control circuit 40 determines if the symbol is a 1D stacked symbol. If it is a 1D stacked symbol, control circuit 40 scans and decodes the remaining CSRs in the stacked symbol. If it is not a stacked symbol, the decoded 1D data is stored or output to display 60 in step 630. In step 638, control circuit 40 determines if there are any unexamined regions. If there are unexamined regions, the decoding process is repeated. Otherwise, control circuit 40 exits the routine.

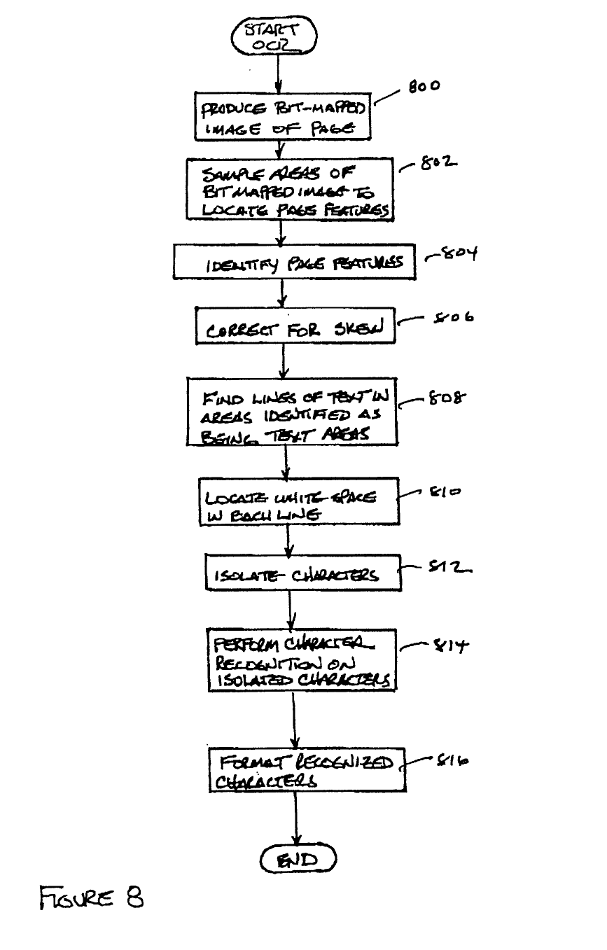

As embodied herein and depicted in FIG. 7, a flow chart showing a method for 2D autodiscrimination is disclosed. In step 700, control circuit 40 converts the image data into a two-state binarized format. In step 702, control circuit 40 locates all 2D finder patterns and identifies them by type. Pattern types include bulls-eye type patterns, waistband type patterns peripheral patterns, and others. If the number of finder patterns equals zero, control circuit 40 exits the routine and returns to the routine depicted in FIG. 5. If there are finder patterns, control circuit 40 locates the finder pattern closest to the center of the field of view in one embodiment of the invention. The closest-to-the-center option has an advantage in that a centrally located image is likely to be a symbol. In step 708, control circuit 40 attempts to decode the symbol in accordance with the finder type. For example, the Aztec 2D matrix symbol employs a bulls-eye finder pattern. The DataMatrix symbology employs a peripheral finder pattern. If the decoding is successful, the decoded data is either stored or displayed. In step 714, control circuit 40 determines if there are any other unused finder patterns. If so, the symbols corresponding to those unused patterns are decoded, and the previously described steps are repeated. Otherwise, control circuit 40 exits the routine.

As embodied herein and depicted in FIG. 8, a flow chart showing a method for reading text is disclosed. This routine can be accessed in a number of ways. For example, the routine may be actuated automatically if symbology decoding fails. A user may also select an OCR option using an appropriate menu driver. Reader 10 can be configured so that such a selection disables symbology decoding. In step 800, an image map frame of image data is captured. In step 802, the image map is sampled. In one embodiment, this is performed by analyzing every Nth scan line of the image. The value of integer N is dependent on the resolution of the scanned image. In one embodiment the image is sampled every 1/40th of an inch. This provides sufficient resolution to locate and classify the various regions on the page. By sampling every 1/40th of an inch instead of every scan line, the processing and memory requirements of reader 10 are substantially reduced. In step 804, control circuit 40 identifies page features. Control circuit 40 may analyze the page and divides it into blank and non-blank portions. The non-blank portions are analyzed to distinguish text regions from non-text regions. After determining the layout of the page, control circuit 40 uses black-to-white transitions to determine degrees of skew. In step 808, horizontal white spaces are identified to separate lines of text. In step 810, vertical white spaces are identified within each line of text to thereby separate individual words and characters from each other. In step 814, a character recognition algorithm is used in an attempt to recognize each individual character. Finally, in step 816, control circuit 40 formats the recovered text before storing the text in memory 45.

Referring again to the flow diagram of FIG. 1d, control circuit 40 determines at block 120 whether decoding was successful. If decoding was successful, control circuit 40 proceeds to block 122 to provide a user with feedback indicating that decoding was successful. This feedback may take the form of an aural feedback output by aural output 14a, such as an audible beep or tone as is indicated by block 122 of the specific example of the flow diagram of FIG. 1e. The user feedback indicating a successful decode may also take the form of a message displayed on display 14d. For example, as is indicated by FIG. 1a control circuit 40 may display on display 14d the message “DECODE SUCCESSFUL” coupled with a message 14m corresponding to the decoded out message. The user feedback indicating a successful decode may also comprise a “good read” led 14g being switched on by control circuit 40.

If at block 120 control circuit 40 determines that the decode attempt has been unsuccessful, then control circuit 40 at block 124 displays on display 14d an image corresponding to a recently captured frame of image data. Control circuit 40 may display an image corresponding to a certain frame of captured image data by writing the frame of image data to display 40. The frame of image data that may be written to display at block 124 is conveniently the frame of image data that has been subjected to an unsuccessful decode attempt at block 118.

After control circuit 40 displays an image on display 14d corresponding to a recently captured image at block 124 control circuit 40 returns to block 116 to capture another frame of image data into memory 45. The process of capturing frames of image data (block 116), subjecting a frame of image data to a decode attempt (block 118) and displaying an image corresponding to a captured frame (block 124) continues until at block 120 control circuit 40 determines that a decode attempt has been successful.

During the time that control circuit 40 continuously executes the loop explained with reference to blocks 116, 118, and 124 a user typically moves reader 10 into a position which is indicated by display 14d to be a position at which decoding is likely to be successful. In the example of FIG. 1d, a user is prompted to move reader 10 rightward and slightly upward since the representation TI_{R} of target indicia TI on display 14d indicates that target indicia TI is positioned rightward and upward relative the center of the field of view of reader 10.

By withholding display of images corresponding to a frame of image data until and unless there is an decoding attempt and the attempt is not successful, a reader according to the invention provides a user with image display feedback which assists a user in positioning reader 10 in an operative position relative to a decodable indicia without distracting a user while he initially positions a reader in proximity with a decodable indicia, and therefore without deleteriously affecting the user's initial positioning of a reader relative to a decodable indicia, which initial positioning can be made with substantial accuracy in the absence of display feedback.

While the present invention has been explained with reference to the structure disclosed herein, it is not confined to the details set forth and this invention is intended to cover any modifications and changes as may come within the scope of the following claims.

What is claimed:

1. An optical reader comprising:
an imaging assembly including an image sensor;
a display;
a control circuit in communication with said imaging assembly and said display, said control circuit adapting said reader to operate in a decode fail image display feedback mode wherein said control circuit when operating in said decode fail image display feedback mode:
(a) captures a frame of image data;
(b) subjects said captured frame of image data to a decoding attempt;
(c) if said decoding attempt is unsuccessful, displays an image on said display corresponding to a recently captured frame and returns to step (a); and
(d) if said decoding attempt is successful, avoids display of an image on said display corresponding to a recently captured image.

2. The reader of claim 1, wherein said reader is configured so that when executing strep (c) said control circuit writes the frame of image data to said display that was subjected to decoding during execution of step (b).

3. The reader of claim 1, wherein said reader is configured so that said decode fail image display feedback mode is a default mode operational when a decoding application of said reader is selected.

4. The reader of claim 1, wherein said reader is configured so that said decode fail image display feedback mode is a user selected mode of operation operational when said control circuit receives a user initiated command initiating said decode fail image display feedback mode.

5. The reader of claim 1, wherein said reader is configured so that operation of said reader in said decode fail image display feedback mode is commenced automatically when said control circuit senses that a predetermined condition has been satisfied.

6. The reader of claim 1, wherein said reader further comprises an illumination assembly and an ambient illumination sensor circuit for sensing a high ambient illumination condition, and wherein said control circuit is configured to be responsive to said ambient illumination sensor circuit so that said decode fail image display feedback mode is commenced automatically when said control circuit, by analysis of an output of said sensor circuit, determines that a high ambient illumination condition is present.

7. The reader of claim 6, wherein said ambient illumination sensor circuit comprises a dedicated photodetector dedicated for sensing a high ambient illumination condition.

8. The reader of claim 6, wherein said ambient illumination sensor circuit comprises said image sensor, wherein said control circuit determines whether a high ambient illumination condition is present based upon a value of at least one pixel of a frame of image data captured by said control circuit.

9. The reader of claim 1, further comprising a graphical user interface and a pointer controller for controlling a position of a pointer of said graphical user interface.

10. The reader of claim 1 wherein said reader further comprises an aural output device, and wherein said reader when executing step (d) controls said aural output device to emit a good read beep.

11. An optical reader for reading a decodable indicia, said reader comprising:
an imaging assembly including an image sensor;
an illumination assembly for illuminating a target area;
a display;
an ambient illumination sensor circuit;
a control circuit in communication with said imaging assembly and said display, being adapted to capture frames of image data, said control circuit adapting said reader to operate in an image display feedback mode, wherein said control circuit displays images corresponding to captured frames of image data on said display to a aid a user in positioning said reader in a proper position relative to said decodable indicia, said control circuit being responsive to said ambient light sensor so that said control circuit automatically operates said reader when said control circuit determines that said ambient illumination sensor circuit indicates that a high ambient illumination condition is present.

12. The reader of claim 11, wherein said ambient illumination sensor circuit comprises a dedicated photodetector for detecting ambient illumination.

13. The reader of claim 11, wherein said ambient illumination sensor circuit comprises said image sensor.

14. The reader of claim 11, wherein said illumination assembly comprise target illumination optics for projecting an aiming pattern onto said target area.
